(19) United States
(12) Patent Application Publication
(10) Pub. No.: US 2025/0070995 A1
(43) Pub. Date: Feb. 27, 2025

(54) SYSTEMS AND METHODS FOR EFFICIENT DUPLICATION AND TRANSMISSION OF LIVE AUDIO DATA

(71) Applicant: Mixhalo Corp., San Francisco, CA (US)

(72) Inventors: Vikram Singh, San Francisco, CA (US); Taylor Galbraith, San Francisco, CA (US)

(21) Appl. No.: 18/811,984

(22) Filed: Aug. 22, 2024

Related U.S. Application Data
(60) Provisional application No. 63/534,012, filed on Aug. 22, 2023.

(51) Int. Cl. H04L 12/18; G06F 3/16

(52) U.S. Cl. CPC H04L 12/189; G06F 3/165

(57) ABSTRACT

A method for duplication and transmission of live audio data to one or more mobile computing devices at a live event includes receiving a live audio signal corresponding to the live event and processing the live audio signal, thereby creating a data representation of the live audio signal. The data representation of the live audio signal including audio data packets. The method also includes duplicating each of the audio data packets into duplicated audio data packets. The method also includes concurrently transmitting the duplicated audio data packets to the one or more mobile computing devices at the live event via a wireless network.

### RELATED APPLICATION(S)

This application claims priority to U.S. Provisional Patent Application No. 63/534,012, filed on Aug. 22, 2023, the entire disclosure of which is incorporated herein by reference.

### FIELD OF THE INVENTION

This invention relates generally to the field of real-time delivery of data over wireless networks. More specifically, the invention relates to systems and methods for efficient duplication and transmission of live audio data to mobile computing devices over wireless networks.

### BACKGROUND

Attendees of live events often bring and use their mobile computing device to stream data (e.g., audio or video) using at least one of the available wireless networks at the venue (e.g., Wi-Fi or cellular). However, due to the large number of attendees at live events, data streaming from the available wireless networks at the venue may suffer from an undesirable or unbearable amount of latency and/or instability. Current server-side solutions focus on techniques for improving packet routing with efficiency but are deficient with respect to transmitting identical data packets to a large number of clients during the same period of time. Therefore, there is a need for systems and methods that allow for rapid and efficient duplication and transmission of live audio data to a large number of mobile computing devices over wireless networks.

### SUMMARY

The present invention includes systems and methods for duplication and transmission of live audio data to one or more mobile computing devices at a live event. For example, the present invention includes systems and methods for receiving a live audio signal corresponding to a live event by an audio server computing device and processing the live audio signal into a data representation of the live audio signal having audio data packets. The present invention also includes systems and methods for duplicating each of the audio data packets and concurrently transmitting the duplicated audio data packets to the one or more mobile computing devices at the live event via a wireless network.

In one aspect, the invention includes a computerized method for duplication and transmission of live audio data to one or more mobile computing devices at a live event. The computerized method includes receiving a live audio signal corresponding to the live event by an audio server computing device. The computerized method also includes processing the live audio signal, thereby creating a data representation of the live audio signal. The data representation of the live audio signal includes audio data packets. The computerized method also includes duplicating each of the audio data packets into duplicated audio data packets. The computerized method also includes concurrently transmitting the duplicated audio data packets to the one or more mobile computing devices at the live event via a wireless network.

In some embodiments, the computerized method further includes transmitting a first duplicated audio data packet to a first mobile computing device at the live event via the wireless network at a first time. For example, in some embodiments, the computerized method further includes transmitting a second duplicated audio data packet to a second mobile computing device at the live event via the wireless network at the first time. In some embodiments, the computerized method further includes transmitting a third duplicated audio data packet to a third mobile computing device at the live event via the wireless network at the first time.

In some embodiments, the computerized method further includes receiving the live audio signal corresponding to the live event via an audio interface communicatively coupled to the audio server computing device.

In another aspect, the invention includes an audio server computing device for duplication and transmission of live audio data to one or more mobile computing devices at a live event. The audio server computing device is configured to receive a live audio signal corresponding to the live event. The audio server computing device is also configured to process the live audio signal, thereby creating a data representation of the live audio signal. The data representation of the live audio signal including audio data packets. The audio server computing device is also configured to duplicate each of the audio data packets into duplicated audio data packets. The audio server computing device is also configured to concurrently transmit the duplicated audio data packets to the one or more mobile computing devices at the live event via a wireless network.

In some embodiments, the audio server computing device is also configured to transmit a first duplicated audio data packet to a first mobile computing device at the live event via the wireless network at a first time. For example, in some embodiments, the audio server computing device is also configured to transmit a second duplicated audio data packet to a second mobile computing device at the live event via the wireless network at the first time. In some embodiments, the audio server computing device is also configured to transmit a third duplicated audio data packet to a third mobile computing device at the live event via the wireless network at the first time.

In some embodiments, the audio server computing device is also configured to receive the live audio signal corresponding to the live event via an audio interface communicatively coupled to the audio server computing device.

In another aspect, the invention includes a system for duplication and transmission of live audio data to one or more mobile computing devices at a live event. The system includes an audio server computing device communicatively coupled to one or more mobile computing devices at a live event over a wireless network. The audio server computing device is configured to receive a live audio signal corresponding to the live event. The audio server computing device is also configured to process the live audio signal, thereby creating a data representation of the live audio signal. The data representation of the live audio signal including audio data packets. The audio server computing device is also configured to duplicate each of the audio data packets into duplicated audio data packets. The audio server computing device is also configured to concurrently transmit the duplicated audio data packets to the one or more mobile computing devices at the live event via the wireless network.

In some embodiments, the audio server computing device is also configured to transmit a first duplicated audio data packet to a first mobile computing device at the live event via the wireless network at a first time. For example, in some embodiments, the first mobile computing device is configured to receive the first duplicated audio data packet.

In some embodiments, the audio server computing device is also configured to transmit a second duplicated audio data packet to a second mobile computing device at the live event via the wireless network at the first time. For example, in some embodiments, the second mobile computing device is configured to receive the second duplicated audio data packet.

In some embodiments, the audio server computing device is also configured to transmit a third duplicated audio data packet to a third mobile computing device at the live event via the wireless network at the first time. For example, in some embodiments, the third mobile computing device is configured to receive the third duplicated audio data packet.

In some embodiments, the system further includes an audio interface communicatively coupled to the audio server computing device. For example, in some embodiments, the audio server computing device is also configured to receive the live audio signal corresponding to the live event via the audio interface communicatively coupled to the audio server computing device. In some embodiments, the system further includes at least one wireless network access point communicatively coupled to the audio server computing device.

These and other aspects of the invention will be more readily understood from the following descriptions of the invention, when taken in conjunction with the accompanying drawings and claims.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a schematic diagram of a system architecture for real-time delivery of live event data over wireless networks, according to an illustrative embodiment of the invention.

FIG. 2 is a schematic diagram of a system architecture for duplication and transmission of live audio data to one or more mobile computing devices at a live event, according to an illustrative embodiment of the invention.

FIG. 3 is a schematic flow diagram illustrating method steps for duplication and transmission of live audio data to one or more mobile computing devices at a live event using the system architecture of FIG. 2, according to an illustrative embodiment of the invention.

### DETAILED DESCRIPTION

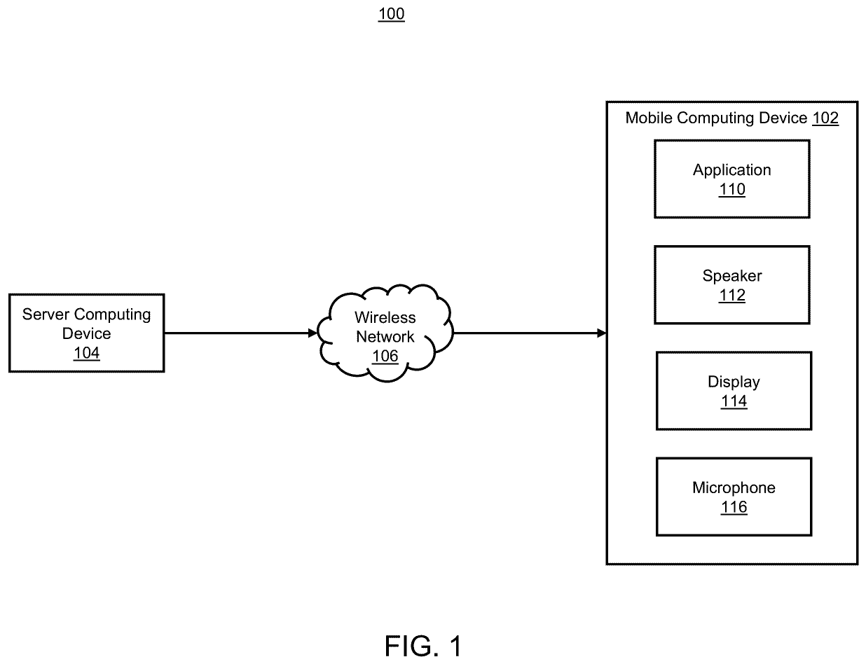

FIG. 1 is a schematic diagram of a system architecture 100 for real-time delivery of live event data over wireless networks, according to an illustrative embodiment of the invention. System 100 includes one or more mobile computing devices 102 communicatively coupled to a server computing device 104 (or audio server computing device) over one or more wireless networks 106. Mobile computing device 102 includes an application 110, one or more speakers 112, one or more displays 114, and one of more microphones 116. In some embodiments, the server computing device 104 is communicatively coupled to an audio interface (not shown).

Exemplary mobile computing devices 102 include, but are not limited to, tablets and smartphones, such as Apple® iPhone®, iPad® and other iOS®-based devices, and Samsung® Galaxy®, Galaxy Tab™ and other Android™-based devices. It should be appreciated that other types of computing devices capable of connecting to and/or interacting with the components of system 100 can be used without departing from the scope of invention. Although FIG. 1 depicts a single mobile computing device 102, it should be appreciated that system 100 can include a plurality of mobile computing devices.

Mobile computing device 102 is configured to receive a data representation of a live audio signal corresponding to the live event via wireless network 106. For example, in some embodiments, mobile computing device 102 is configured to receive the data representation of the live audio signal corresponding to the live event from server computing device 104 via wireless network 106, where server computing device 104 is coupled to an audio source at the live event (e.g., a soundboard that is capturing live audio). Mobile computing device 102 is also configured to process the data representation of the live audio signal into a live audio stream.

Mobile computing device 102 is also configured to initiate playback of the live audio stream via a first headphone (not shown) communicatively coupled to the mobile computing device 102 at the live event. For example, the user of mobile computing device 102 can connect a headphone to the device via a wired connection (e.g., by plugging the headphone into a jack on the mobile computing device) or via a wireless connection (e.g., pairing the headphone to the mobile computing device via a short-range communication protocol such as Bluetooth™). Mobile computing device 102 can then initiate playback of the live audio stream via the headphone.

Additional detail regarding illustrative technical features of the methods and systems described herein are found in U.S. Pat. No. 11,461,070, titled “Systems and Methods for Providing Real-Time Audio and Data” and issued Oct. 24, 2022, and U.S. Pat. No. 11,625,213, titled “Systems and Methods for Providing Real-Time Audio and Data,” and issued Apr. 11, 2023, the entirety of each of which is incorporated herein by reference.

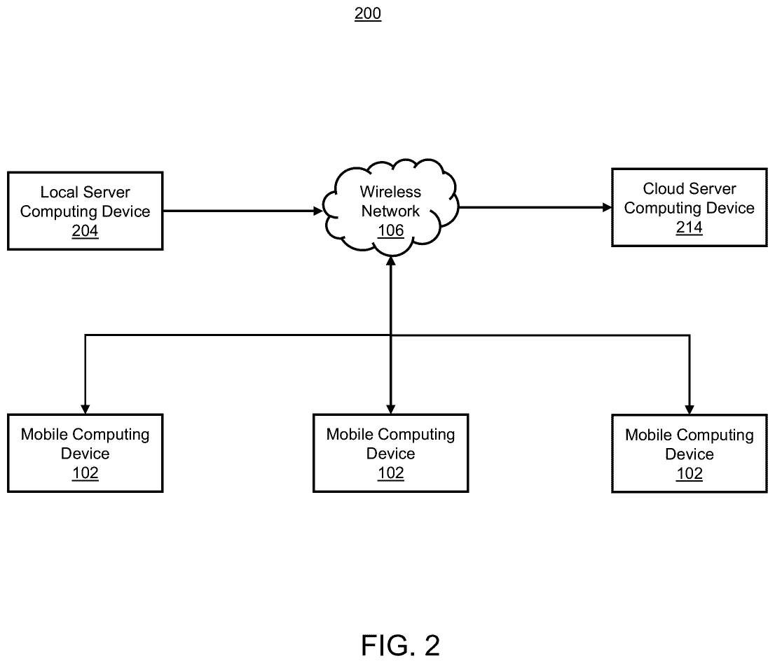

FIG. 2 is a schematic diagram of a system architecture 200 for duplication and transmission of live audio data to one or more mobile computing devices at a live event, according to an illustrative embodiment of the invention. Similar to system 100, system 200 includes a local server computing device 204 (or local audio server computing device) communicatively coupled to a cloud server computing device 214 (or cloud-based audio server computing device) via the wireless network 106. System 200 also includes at least two or more mobile computing devices 102 communicatively coupled to the cloud server computing device 214 via the wireless network 106.

Local server computing device 204 includes specialized hardware and/or software modules that execute on one or more processors and interact with one or more memory modules of server computing device 204, to receive data from other components of system 200, transmit data to other components of system 200, and perform functions for capturing a live audio signal and transmitting audio packets corresponding to the live audio signal to cloud server computing device 214 as described herein. In some embodiments, local server computing device 204 comprises software modules that carry out the audio signal processing described herein, where the modules are specialized sets of computer software instructions programmed onto one or more dedicated processors in local server computing device 204 and can include specifically designated memory locations and/or registers for executing the specialized computer software instructions.

Cloud server computing device 214 is a combination of hardware, including one or more computing devices comprised of special-purpose processors and one or more physical memory modules, and specialized software in a cloud computing environment, to receive and process audio signal packets from local server computing device 204. Exemplary cloud computing platforms that can be used for cloud server computing device 214 include, but are not limited to, Amazon® Web Services (AWS); IBM® Cloud™; Google® Cloud™; and Microsoft® Azure™. It should be appreciated that other types of resource distribution, allocation, and configuration in a cloud-based computing environment can be used within the scope of the technology described herein.

System 200 can be configured for duplication and transmission of live audio data to one or more mobile computing devices 102 at a live event. For example, cloud audio server computing device 214 can be configured to receive a live audio signal corresponding to the live event. In some embodiments, cloud audio server computing device 214 is configured to receive the live audio signal corresponding to the live event from local audio server computing device 204 via wireless network 106. Cloud audio server computing device 214 can also be configured to process the live audio signal, thereby creating a data representation of the live audio signal. The data representation of the live audio signal including audio data packets. Cloud audio server computing device 214 can also be configured to duplicate each of the audio data packets into duplicated audio data packets. Cloud audio server computing device 214 is also configured to concurrently transmit the duplicated audio data packets to the one or more mobile computing devices 102 at the live event via wireless network 106.

In some embodiments, cloud audio server computing device 214 is also configured to transmit a first duplicated audio data packet to a first mobile computing device 102 at the live event via wireless network 106 at a first time. For example, in some embodiments, the first mobile computing device 102 is configured to receive the first duplicated audio data packet.

In some embodiments, cloud audio server computing device 214 is also configured to transmit a second duplicated audio data packet to a second mobile computing device 102 at the live event via wireless network 106 at the first time. For example, in some embodiments, the second mobile computing device 102 is configured to receive the second duplicated audio data packet.

In some embodiments, cloud audio server computing device 214 is also configured to transmit a third duplicated audio data packet to a third mobile computing device 102 at the live event via wireless network 106 at the first time. For example, in some embodiments, the third mobile computing device 102 is configured to receive the third duplicated audio data packet.

In some embodiments, system 200 further includes an audio interface communicatively coupled to local audio server computing device 204. For example, in some embodiments, local audio server computing device 204 is also configured to receive the live audio signal corresponding to the live event via the audio interface communicatively coupled to local audio server computing device 204. In some embodiments, the system further includes at least one wireless network access point communicatively coupled to local audio server computing device 204.

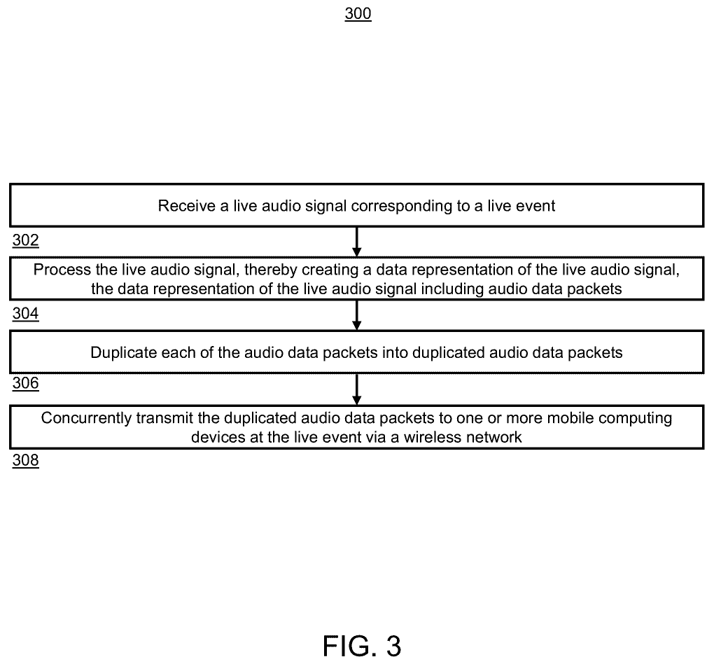

FIG. 3 is a schematic flow diagram illustrating a computerized process 300 for duplication and transmission of live audio data to one or more mobile computing devices 102 at a live event using system 200, according to an illustrative embodiment of the invention. Process 300 begins by receiving a live audio signal corresponding to the live event by an audio server computing device (i.e., cloud server computing device 214) at step 302. Process 300 continues by processing the live audio signal, thereby creating a data representation of the live audio signal at step 304. The data representation of the live audio signal includes audio data packets. Process 300 continues by duplicating each of the audio data packets into duplicated audio data packets at step 306. Process 300 finished by concurrently transmitting the duplicated audio data packets to the one or more mobile computing devices 102 at the live event via a wireless network 106 at step 308.

In some embodiments, process 300 further includes transmitting a first duplicated audio data packet to a first mobile computing device 102 at the live event via the wireless network 106 at a first time. For example, in some embodiments, process 300 further includes transmitting a second duplicated audio data packet to a second mobile computing device 102 at the live event via the wireless network 106 at the first time. In some embodiments, process 300 further includes transmitting a third duplicated audio data packet to a third mobile computing device 102 at the live event via the wireless network 106 at the first time.

In some embodiments, process 300 further includes receiving the live audio signal corresponding to the live event via an audio interface communicatively coupled to the local audio server computing device 204.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account-which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™ Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN)), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A computerized method for duplication and transmission of live audio data to a plurality of mobile computing devices at a live event, the method comprising:
receiving, by an audio server computing device, a live audio signal corresponding to the live event;
processing, by the audio server computing device, the live audio signal, thereby creating a data representation of the live audio signal, the data representation of the live audio signal comprising a plurality of audio data packets;
duplicating, by the audio server computing device, each of the plurality of audio data packets into a plurality of duplicated audio data packets; and
concurrently transmitting, by the audio server computing device, the plurality of duplicated audio data packets to the plurality of mobile computing devices at the live event via a wireless network.

2. The computerized method of claim 1, wherein concurrently transmitting the plurality of duplicated audio data packets to the plurality of mobile computing devices at the live event via the wireless network comprises:
transmitting, by the audio server computing device, a first duplicated audio data packet of the plurality of duplicated audio data packets to a first mobile computing device of the plurality of mobile computing devices at the live event via the wireless network at a first time.

3. The computerized method of claim 2, wherein concurrently transmitting the plurality of duplicated audio data packets to the plurality of mobile computing devices at the live event via the wireless network further comprises:
transmitting, by the audio server computing device, a second duplicated audio data packet of the plurality of duplicated audio data packets to a second mobile computing device of the plurality of mobile computing devices at the live event via the wireless network at the first time.

4. The computerized method of claim 3, wherein concurrently transmitting the plurality of duplicated audio data packets to the plurality of mobile computing devices at the live event via the wireless network further comprises:
transmitting, by the audio server computing device, a third duplicated audio data packet of the plurality of duplicated audio data packets to a third mobile computing device of the plurality of mobile computing devices at the live event via the wireless network at the first time.

5. The computerized method of claim 1, wherein receiving the live audio signal corresponding to the live event comprises:
receiving, by the audio server computing device, the live audio signal corresponding to the live event via an audio interface communicatively coupled to the audio server computing device.

6. An audio server computing device for duplication and transmission of live audio data to a plurality of mobile computing devices at a live event, the audio server computing device configured to:
receive a live audio signal corresponding to the live event;
process the live audio signal, thereby creating a data representation of the live audio signal, the data representation of the live audio signal comprising a plurality of audio data packets;
duplicate each of the plurality of audio data packets into a plurality of duplicated audio data packets; and
concurrently transmit the plurality of duplicated audio data packets to the plurality of mobile computing devices at the live event via a wireless network.

7. The audio server computing device of claim 6, wherein the audio server computing device is configured to concurrently transmit the plurality of duplicated audio data packets to the plurality of mobile computing devices at the live event via the wireless network by:
transmitting a first duplicated audio data packet of the plurality of duplicated audio data packets to a first mobile computing device of the plurality of mobile computing devices at the live event via the wireless network at a first time.

8. The audio server computing device of claim 7, wherein the audio server computing device is further configured to concurrently transmit the plurality of duplicated audio data packets to the plurality of mobile computing devices at the live event via the wireless network by:
transmitting a second duplicated audio data packet of the plurality of duplicated audio data packets to a second mobile computing device of the plurality of mobile computing devices at the live event via the wireless network at the first time.

9. The audio server computing device of claim 8, wherein the audio server computing device is further configured to concurrently transmit the plurality of duplicated audio data packets to the plurality of mobile computing devices at the live event via the wireless network by:
transmitting a third duplicated audio data packet of the plurality of duplicated audio data packets to a third mobile computing device of the plurality of mobile computing devices at the live event via the wireless network at the first time.

10. The audio server computing device of claim 6, wherein the audio server computing device is configured to receive the live audio signal corresponding to the live event by:
receiving the live audio signal corresponding to the live event via an audio interface communicatively coupled to the audio server computing device.

11. A system for duplication and transmission of live audio data to a plurality of mobile computing devices at a live event, the system comprising:
an audio server computing device communicatively coupled to a plurality of mobile computing devices at a live event over a wireless network, the audio server computing device configured to:
receive a live audio signal corresponding to the live event;
process the live audio signal, thereby creating a data representation of the live audio signal, the data representation of the live audio signal comprising a plurality of audio data packets;
duplicate each of the plurality of audio data packets into a plurality of duplicated audio data packets; and
concurrently transmit the plurality of duplicated audio data packets to the plurality of mobile computing devices at the live event via the wireless network.

12. The system of claim 11, wherein the audio server computing device is configured to concurrently transmit the plurality of duplicated audio data packets to the plurality of mobile computing devices at the live event via the wireless network by:
transmitting a first duplicated audio data packet of the plurality of duplicated audio data packets to a first mobile computing device of the plurality of mobile computing devices at the live event via the wireless network at a first time.

13. The system of claim 12, wherein the first mobile computing device of the plurality of mobile computing devices at the live event is configured to:
receive the first duplicated audio data packet of the plurality of duplicated audio data packets.

14. The system of claim 12, wherein the audio server computing device is further configured to concurrently transmit the plurality of duplicated audio data packets to the plurality of mobile computing devices at the live event via the wireless network by:
transmitting a second duplicated audio data packet of the plurality of duplicated audio data packets to a second mobile computing device of the plurality of mobile computing devices at the live event via the wireless network at the first time.

15. The system of claim 14, wherein the second mobile computing device of the plurality of mobile computing devices at the live event is configured to:
receive the second duplicated audio data packet of the plurality of duplicated audio data packets.

16. The system of claim 14, wherein the audio server computing device is further configured to concurrently transmit the plurality of duplicated audio data packets to the plurality of mobile computing devices at the live event via the wireless network by:
transmitting a third duplicated audio data packet of the plurality of duplicated audio data packets to a third mobile computing device of the plurality of mobile computing devices at the live event via the wireless network at the first time.

17. The system of claim 16, wherein the third mobile computing device of the plurality of mobile computing devices at the live event is configured to:
receive the third duplicated audio data packet of the plurality of duplicated audio data packets.

18. The system of claim 11, further comprising an audio interface communicatively coupled to the audio server computing device.

19. The system of claim 18, wherein the audio server computing device is configured to receive the live audio signal corresponding to the live event by:
receiving the live audio signal corresponding to the live event via the audio interface communicatively coupled to the audio server computing device.

20. The system of claim 11, further comprising at least one wireless network access point communicatively coupled to the audio server computing device.
